(19) United States
(12) Patent Application Publication
(10) Pub. No.: US 2018/0247446 A1
(43) Pub. Date: Aug. 30, 2018

(54) METHOD AND SYSTEM UTILIZING TEXTURE MAPPING

(71) Applicant: INFIME DEVELOPMENT LTD., Mevaseret Ziyon (IL)

(72) Inventor: Michael LITVIN, Tel Aviv (IL)

(21) Appl. No.: 15/763,447

(22) PCT Filed: Sep. 28, 2016
(86) PCT No.: PCT/IL16/51064

§ 371 Date: Mar. 27, 2018

Related U.S. Application Data
(60) Provisional application No. 62/233,746, filed on Sep. 28, 2015.

(51) Int. Cl. G06T 15/04; G06T 19/20; G06T 17/20

(52) U.S. Cl. CPC G06T 15/04; G06T 19/20; G06T 2207/30196; G06T 2210/16; G06T 17/20

(57) ABSTRACT

Methods and systems are disclosed, which utilize texture mapping to rapidly map flexible physical objects onto 3D models. The 3D models are represented graphically.

### CROSS REFERENCES TO RELATED APPLICATIONS

This application is related to and claims priority from commonly owned US Provisional Patent Application Ser. No. 62/233,746, entitled: Two-Stage Texture Mapping From Flexible Surfaces On 3D Models, filed on Sep. 28, 2015, the disclosure of which is incorporated by reference in its entirety herein.

### TECHNICAL FIELD

The present invention relates to computer graphics and more particularly, to use of texture mapping concepts in computer graphics.

### BACKGROUND

Texture mapping is a computer graphics process where a set of pixels or a 2D (two dimensional) image, called a texture map, is mapped and wrapped around a 3D (three dimensional) surface. As a result, the 3D surface acquires a surface texture determined by that of the 2D surface and the texture map, Texture mapping has been used in computer video games, such as Minecraft™.

### SUMMARY OF THE INVENTION

The present invention utilizes texture mapping to rapidly map flexible physical objects onto 3D models. The 3D models are, for example, represented graphically. One exemplary application of the texture mapping of the invention involved methods and systems for mapping a flexible item, such as an article of clothing, onto a 3D model, such as a model of a human. This allows for a virtual try-on of the clothing article.

Such virtual try-ons are important, tier two reasons. First, some clothing items, such as underwear, bathing suits may not be tried on by a user due to health and hygienic reasons. Another use of virtual try-ons is when the buyer or user is located remotely from the actual clothing item, and cannot get to the site where the clothing item is.

This document references terms that are used consistently or interchangeably herein. These terms, including variations thereof, are as follows.

A “texture map” is a map formed of a two dimensional (2D) or UV portion of a mesh of vertices, and a three dimensional (3D) portion of a mesh of vertices, each of which corresponds to a vertex of the 2D mesh portion, and vice versa. “UV” is a standard terminology representing the planar coordinates in two dimensions, the “U” dimension and the “V” dimension, analogous to the “x” and “y” planar dimensions.

A uniform resource locator (URL) is the unique address for a file, such as a web site or a web page that is accessible over Networks including the Internet.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices (also known as mobile computers) that can be readily transported from one location to another location (e.g., smartphone, personal digital assistant (PDA), mobile telephone or cellular telephone).

A server is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

Embodiments of the invention are directed to a computer-implemented method for mapping graphics onto a three dimensional (3D) model. The computer-implemented method comprises: calibrating a form to a graphical representation of a 3D model by creating at least one texture map from at least one image of a first article on the form; and, graphically rendering a second article on the graphical representation of the 3D model from images of the second article on the form, by applying the images to the graphical representation of the 3D model in accordance with the calibration of the form to the graphical representation of the 3D model.

Optionally, the form includes a stencil.

Optionally, the first and second articles are flexible articles, different from each other.

Optionally, the flexible articles include at least one of clothing, underwear, shorts, bras, swimsuits, and form-fining clothing.

Optionally, the graphical representation of the 3D model includes a mesh, defining a three dimensional (3D) portion of the at least one texture map.

Optionally, the images of the first article on the form include photographs.

Optionally, the calibrating includes: obtaining at least one image of a calibration surface of the first flexible article on the stencil, the calibration surface defined by a pattern on the first flexible article; and, obtaining the graphical representation of the 3D model in the form of a mesh, the mesh including points in a predetermined order.

Optionally, the at least one texture map is created by correlating points from the mesh of the graphical representation of the 3D model to points of the calibration surface of the first flexible article on the stencil.

Optionally, the predetermined points of the mesh of the graphical representation of the 3D model and the points of the calibration surface define vertices, and the vertices of the mesh of the graphical representation of the 3D model are correlated to the vertices of the calibration surface to define the at least one texture map, the vertices of the calibration surface defining a two dimensional portion of the at least one texture map associated with the stencil.

Optionally, the graphically rendering comprises: obtaining at least one image of a second flexible article on the stencil; obtaining the graphical representation of the 3D model including the mesh; and, obtaining the at least one texture map associated with the stencil and the graphical representation of the 3D model.

Optionally, the computer-implemented method additionally comprises: superimposing the two dimensional portion of the at least one texture map associated with the stencil over the at least one image of the second flexible article on the stencil.

Optionally, the computer-implemented method additionally comprises: mapping the two dimensional portion of the at least one texture map associated with the stencil to the mesh of the graphical representation of the 3D model via the correlated vertices.

Optionally, the computer-implemented method additionally comprises: rendering the second flexible article onto the mesh of the graphical representation of the 3D model using the correlated vertices to wrap the second flexible article onto the graphical representation of the 3D model.

Other embodiments of the present invention are directed to a computer system for mapping graphics onto a three dimensional (3D) model. The computer system comprises: a processor, and, a data storage device. The data storage device has stored thereon, instructions, which when executed by the processor, cause the computer system to perform operations. The operations comprise: calibrating a form to a graphical representation of a 3D model by creating at least one texture map from at least one image of a first article on the form; and, graphically rendering a second article on the graphical representation of the 3D model from images of the second article on the form as applied to the graphical representation of the 3D model in accordance with the calibration of the form to the graphical representation of the 3D model.

Optionally, in the computer system, the form includes a stencil.

Optionally, in the computer system, the first and second articles are flexible articles, different from each other.

Optionally, in the computer system, the flexible articles include at least one of clothing, underwear, shorts, bras, swimsuits, and form-fitting clothing.

Optionally, in the computer system, the graphical representation of the 3D model includes a mesh, defining a portion of the at least one texture map.

Optionally, in the computer system, the images of the first article on the form include photographs.

Optionally, in the computer system, the calibrating comprises: obtaining at least one image of a calibration surface of the first flexible article on the stencil, the calibration surface defined by a pattern on the first flexible article; and, obtaining the graphical representation of the 3D model in the form of a mesh, the mesh including points in a predetermined order.

Optionally, in the computer system, the at least one texture map is created by correlating points from the mesh of the graphical representation of the 3D model to points of the calibration surface of the first flexible article on the stencil.

Optionally, in the computer system, the predetermined points of the mesh of the graphical representation of the 3D model and the points of the calibration surface define vertices, and the vertices of the mesh of the graphical representation of the 3D model are correlated to the vertices of the calibration surface to define the at least one texture map, the vertices of the calibration surface defining a two dimensional portion of the at least one texture map associated with the stencil.

Optionally, in the computer system, the graphically rendering comprises: obtaining at least one image of a second flexible article on the stencil; obtaining the graphical representation of the 3D model including the mesh; and, obtaining the at least one texture map associated with the stencil and the graphical representation of the 3D model.

Optionally, in the computer system, the graphically rendering additionally comprises: superimposing the two dimensional portion of the at least one texture map associated with the stencil over the at least one image of the second flexible article on the stencil.

Optionally, in the computer system, the graphically rendering additionally comprises: mapping the two dimensional portion of the at least one texture map associated with the stencil to the mesh of the graphical representation of the 3D model via the correlated vertices.

Optionally, in the computer system, the graphically rendering additionally comprises: rendering the second flexible article onto the mesh of the graphical representation of the 3D model using the correlated vertices to wrap the second flexible article onto the graphical representation of the 3D model.

Embodiments of the present invention are directed to a non-transitory computer-readable medium having stored thereon instructions that are executable to cause a computer system to perform operations. The operations comprise: calibrating a stencil to a graphical representation of a 3D model by creating at least one texture map from at least one image of a first article on the form; and, graphically rendering a second article on the graphical representation of the 3D model from images of the second article on the stencil as applied to the graphical representation of the 3D model in accordance with the calibration of the stencil to the graphical representation of the 3D model.

Optionally, in the non-transitory computer-readable medium, the first and second articles are flexible articles, different from each other, and, the flexible articles include at least one of clothing, underwear, shorts, bras, swimsuits, and form-fitting clothing.

Optionally, in the non-transitory computer-readable medium, the graphical representation of the 3D model includes a mesh, defining a portion of the at least one texture map.

Optionally, in the non-transitory computer-readable medium, the images of the first article on the stencil include photographs.

Optionally, in the non-transitory computer-readable medium, the calibrating comprises: obtaining at least one image of a calibration surface of the first flexible article on the stencil, the calibration surface defined by a pattern on the first flexible article; and, obtaining the graphical representation of the 3D model in the form of a mesh, the mesh including points in a predetermined order.

Optionally, in the non-transitory computer-readable medium, the at least one texture map is created by correlating points from the mesh to points of the calibration surface of the first flexible article on the stencil.

Optionally, in the non-transitory computer-readable medium, the predetermined points of the mesh of the graphical representation of the 3D model and the points of the calibration surface define vertices, and the vertices of the mesh of the graphical representation of the 3D model are correlated to the vertices of the calibration surface to define the at least one texture map, the vertices of the calibration surface defining a two dimensional portion of the at least one texture map associated with the stencil.

Optionally, in the non-transitory computer-readable medium, the graphically rendering comprises: obtaining at least one image of a second flexible article on the stencil; obtaining the graphical representation of the 3D model including the mesh; and, obtaining the at least one texture map associated with the stencil and the graphical representation of the 3D model.

Optionally, in the non-transitory computer-readable medium, the graphically rendering additionally comprises: superimposing the two dimensional portion of the at least one texture map associated with the stencil over the at least one image of the second flexible article on the stencil.

Optionally, in the non-transitory computer-readable medium, the graphically rendering additionally comprises: mapping the two dimensional portion of the at least one texture map associated with the stencil to the mesh of the graphical representation of the 3D model via the correlated vertices.

Optionally, in the non-transitory computer-readable medium, the graphically rendering additionally comprises: rendering the second flexible article onto the mesh of the graphical representation of the 3D model using the correlated vertices to wrap the second flexible article onto the graphical representation of the 3D model.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1A is a diagram of an exemplary environment for the system in which embodiments of the disclosed subject matter are performed;

FIG. 1B is an example stencil used with the present invention;

FIG. 1C shows a flexible article with a calibration surface on a human model;

FIG. 2 is a diagram of the architecture of the home server of FIG. 1A;

FIG. 3 is a flow diagram of processes in accordance with embodiments of the disclosed subject matter;

FIG. 4A is a flow diagram of the calibration process of the flow diagram of FIG. 3;

FIG. 4B is a flow diagram of the modeling process of the flow diagram of FIG, 3;

FIGS. 5A-1, and 5A-2 are images of a flexible article with a calibration surface on a form or stencil, from the front and rear of the form or stencil, respectively;

FIG. 5B is a graphic of a mesh for a graphical representation of a 3D model;

FIGS. 5C-1 and 5C-2 are images of the form or stencil with a 2D mesh over the flexible article as part of the calibration process;

FIG. 5D is an image of a graphical representation of a 3D model during the calibration process;

FIGS. 6A-1 and 6A-2 show a flexible article on a form or stencil from the front and rear, respectively, as part of the modeling process of the invention;

FIGS. 6B-1 and 6B-2 are images of the form of stencil during the modeling process;

FIGS. 6C and 6D are images of the graphical representation of the 3D model during the modeling process;

FIG. 7 shows a modeled surface on the stencil with the stencil removed;

FIG. 8 shows the modeled surface of FIG. 7 as mapped on a 3D model;

FIG. 9 shows a warped modeled surface on a stencil with the stencil removed; and,

FIG. 10 shows a warped modeled surface mapped on a 3D model.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an. embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

The present invention provides methods and systems which use texture mapping to place articles, such as flexible articles onto 3D (three dimensional) forms, such as 3D models, for example, graphical representations of 3D models (hereinafter, “3D model” singular and plural, and “graphical (or graphic) representation(s) of (a) 3D model(s)”, are used interchangeably herein in the text and in the drawings, except where specifically noted). The disclosed subject matter utilizes point correspondence between points, e.g., vertices, in a 3D model, represented by a mesh (also referred to herein as a 3D mesh), to those vertices of a 2D or UV map, also represented by a mesh (also referred to herein as a 2D mesh), which is a single plane image, In one exemplary application, the texture mapping and texture map(s) of the invention are used to place flexible articles, such as physical clothing articles, onto a 3D model, such as graphical representations of a human body or garments, allowing, for example, a virtual clothing try-on.

The present invention provides for the rapid determination of texture maps for flexible objects, which are previously unmapped, onto provided 3D models, based on the images of the objects and the 3D models.

The present invention provides for texture mapping to place articles, such as flexible articles onto 3D forms, such as 3D models, by a two part process.

First, a calibration is performed. Its purpose is to match points on a stencil, or photograph(s) thereof, to points on the 3D model. The calibration includes calibrating a form, e.g. a stencil, to a 3D model, e.g., a graphical representation of a 3D model, by creating one or more texture maps from one or more images of an article (e.g., a first article), for example, a flexible article such as clothing, on the form or stencil. The calibration results in the creation of one or more texture maps, each texture map including a 2D or UV portion, based on the stencil, for example, represented as a mesh formed of points or vertices, and a 3D portion based on the 3D model, for example, represented as a mesh formed of vertices. The points or vertices of the 2D or UV portion are mapped to correlated or corresponding points or vertices of the mesh of the 3D model.

Next is modeling of an article, typically another article (e.g., a second article) that is different from the flexible article used in the calibration. The article, for example, a flexible article such as clothing, is placed on the form, e.g. the stencil, and wrapped onto the 3D model (from the calibration), using the texture map(s) created during the calibration.

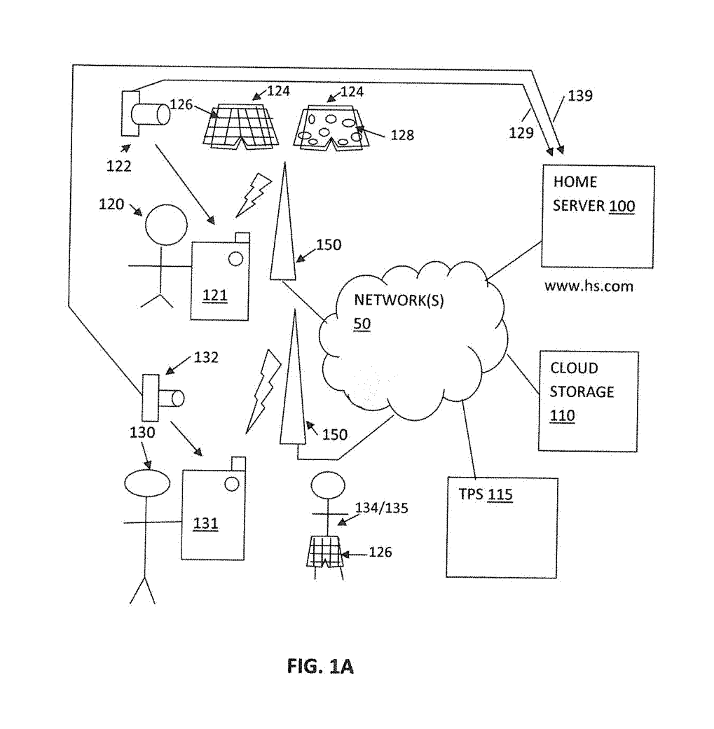

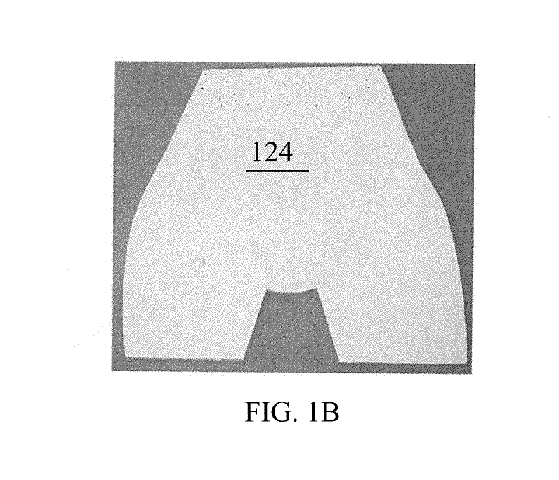

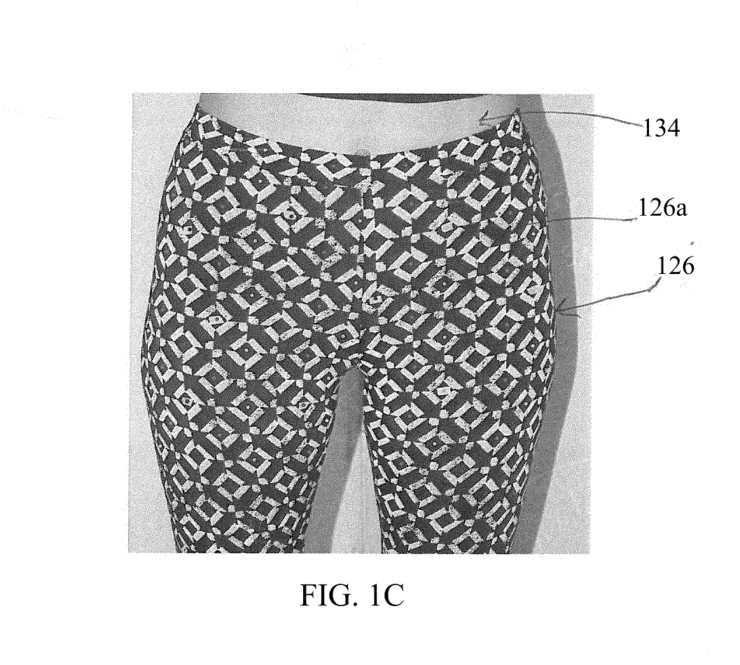

Reference is now made to FIG. 1A, which is a diagram of an exemplary environment of the invention. This environment includes a network 50, to which is linked a home server (HS) 100, also known as a main server. The home server 100 also defines a system 100′, either alone or with other, computers, including servers, components, and applications, e.g., client applications, associated with either the home server 100, as detailed below. A server 110 representing cloud storage, for various storage applications, including storing data generated by the home server 100 is also linked to the network. There is also a server 115, which is, for example, a third party server (TPS), representing various third party venders, such as those from whom computer 3D models (typically in the form of meshes), and other software and computer graphics tools can be obtained.

The network 50 is, for example, a communications network, such as a Local Area Network (LAN), or a Wide Area Network (WAN), including public networks such as the Internet. The network 50 is either a single network or a combination of networks and/or multiple networks, including also (in addition to the aforementioned communications networks such as the Internet), for example, cellular networks. “Linked” as used herein includes both wired or wireless links, either direct or indirect, and placing the computers, including, servers, components and the like, in electronic and/or data communications with each other.

Various users 120, 130 access the network 50. These users 120, 130 are representative of multitudes of users.

A first user 120, with a smart phone (mobile computer) 121 and a camera 122, photographs flexible articles on the same stencil 124. The stencil 124 is, for example, a form, which is, for example, flat or planar, such as a flat cardboard or other similar material, e.g., rigid, resembling a human being or part thereof, such as a lower torso, as shown in FIG. 1B. The stencil 124 is such that objects, such as flexible articles, such as clothing articles, can be placed on/over. A first flexible article on the stencil 124 is a pair of checkerboard or patterned shorts 126, and the second flexible article on the stencil 124 is a pair of polka dot shorts 128. Other flexible articles useful on the stencil 124 or other similar stencils include, for example, underwear, bathing suits, bras, other form-fitting clothing, and the like. In the exemplary process described below, the checkerboard shorts 126 on the stencil 124 are used in the calibration process while the polka dotted shorts 128 are the subject for the modeling process, resulting in the virtual clothing try-on.

The smart phone 121 links to the network 50 via a cellular tower 150, but could also be through WIFI® (not shown). The camera of the smart phone 121 may be used to photograph both of the shorts 126, 128 on the stencil at different times, as detailed below, with the photographs sent to the home server 100 over the network 50. Also, the camera 122 may be used to photograph both of the shorts 126, 128 on the stencil 124 at different times, as detailed below, with the photographs provided to the home server 100 either manually, e.g., delivery of actually photographs, digitally on recorded media, such as Compact Discs and the like, or transmitted over the network 50 via computer (or the smart phone 121). All of these methods are represented by the arrow 129.

A second user 130, with a smart phone (mobile computer) 131 and a camera 132, photographs flexible articles on a reference object 134 such as a live human model 135, mannequin, or other human form. In accordance with the invention, the model 135 is photographed with the checkerboard or patterned shorts 126′, known as a calibration surface (as shown in FIG. 1C), which has the pattern 126a. The flexible article 126′ is similar or identical to the article 126 (on the stencil 124) These photographs of the patterned shorts 126′ on the reference object 134, e.g., model 135, may be used as a guide for the calibration portion of the process detailed below.

The smart phone 131 links to the network 50 via a cellular tower 150, but could also be through WIFI® (not shown). The camera of the smart phone 131 may be used to photograph the shorts 126 on the reference object 134, e.g., the model 135, with the photographs sent to the home server 100 over the network 50. Also, the camera 132 may be used to photograph the shorts 126 on the reference object 134, e.g., the model 135, with the photographs provided to the home server 100 either manually, e.g., delivery of actual photographs, digitally on recorded media, such as Compact Discs and the like, or transmitted over the network 50 via computer (or the smart phone 131). All of these methods are represented by the arrow 139.

The home server (HS) 100 is of an architecture that includes one or more components, engines, modules and the like, for providing numerous additional server functions and operations, and, which form a system 100′, also known as a computer system, for performing the processes (methods) of the invention. The home server (HS) 100 may be associated with additional storage, memory, caches and databases, both internal and external thereto. For explanation purposes, the home server (HS) 100 may have a uniform resource locator (URL) of, for example, www.hs.com. While a single home server (HS) 100 is shown, the home server (HS) 100 may be formed of multiple servers and/or components.

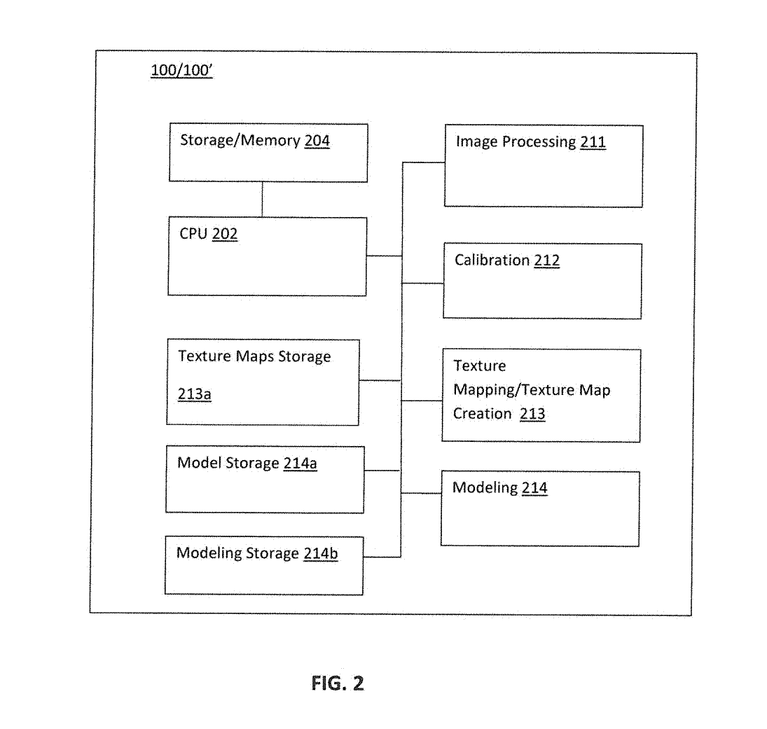

Attention is now directed to FIG. 2, which shows the architecture of the system 100′, for example, in the home server 100. This architecture of the system 100′, as shown, for example, in the home server 100, includes a central processing unit (CPU) 202 formed of one or more processors, electronically connected, including in electronic and/or data communication with storage/memory 204, and modules 211-214, and storage media 213a, 214a, 214b. Storage media 312a is, for example, for storage of texture maps. Storage media 214a is for 3D models, for example, in the form of meshes, formed of points or vertices, while storage media 214b is for actually modeled articles on the respective 3D models. The aforementioned components 211-214, 213a, 214a and 214b render the server 100 as a special purpose computer. Also, while all of the components of the system 100′ are shown in an example linkage, they are all is electronic and/or data communication either directly or indirectly.

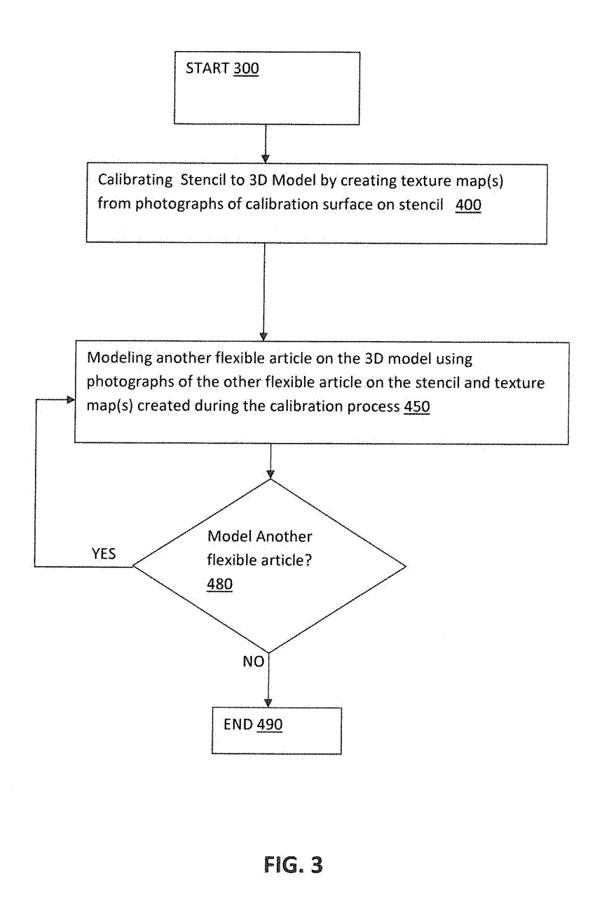

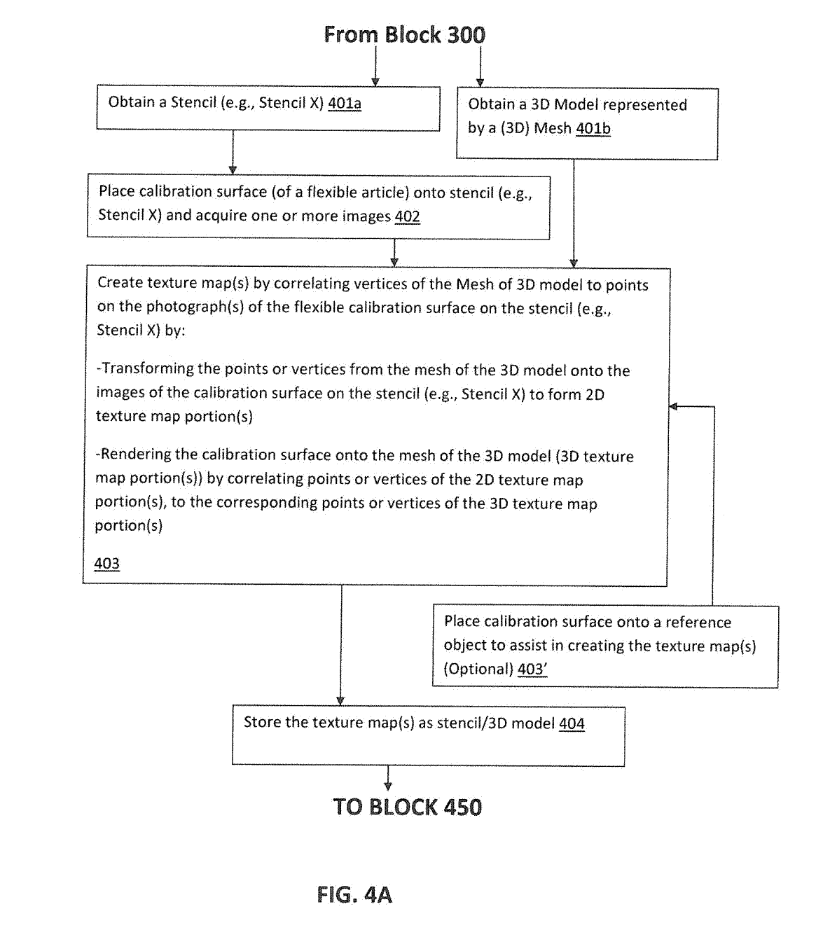

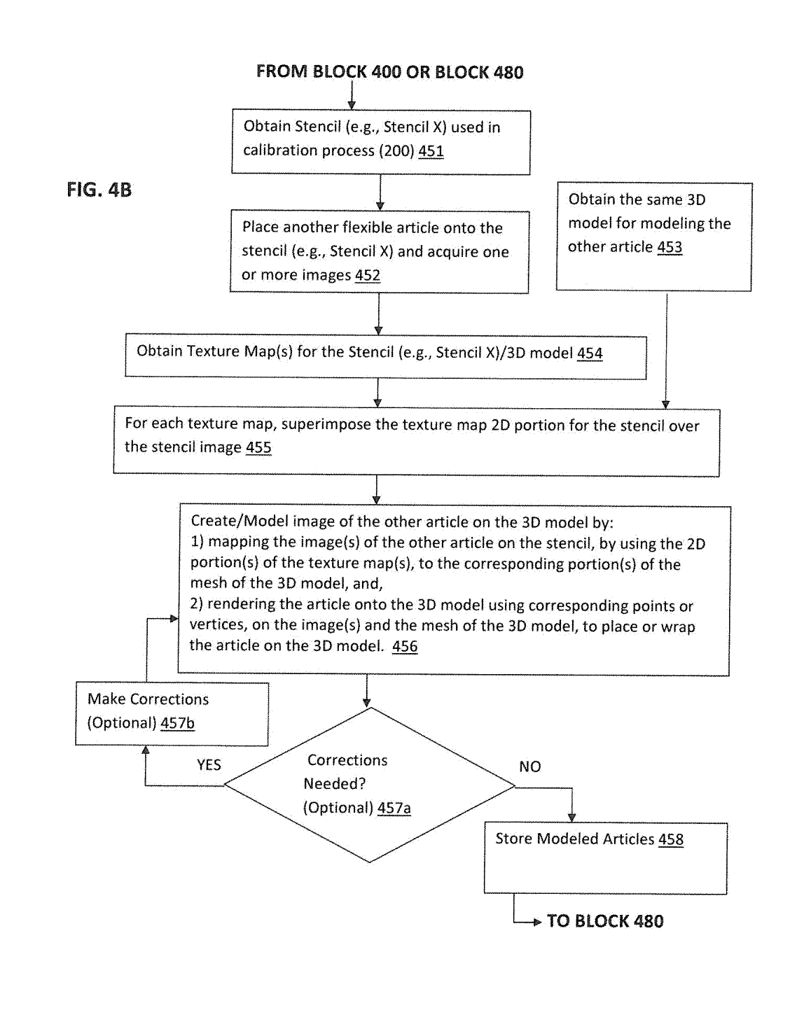

The Central Processing Unit (CPU) 202 is formed of one or more processors, including microprocessors, for performing the home server 100 and system 100′ functions and operations detailed herein, including controlling the storage media 204, modules 211-214 and storage media 213a, along with the processes and subprocesses shown in FIGS. 3, 4A, and 4B, as detailed below. The processors are, for example, conventional processors, such as those used in servers, computers, and other computerized devices. For example, the processors may include x86 Processors from AMD and Intel, Xenon® and Pentium® processors from Intel, as well as any combinations thereof.

The storage/memory 204 is any conventional storage media. The storage/memory 204, is for example, a data storage device, that stores machine executable instructions for execution by the CPU 202, to perform the processes of the invention. The storage/memory 204 also includes and stores machine executable instructions associated with the operation of the components, including the modules 211-214, the storage media 213a, 214a, 214b, and all instructions for executing the processes of FIGS. 3, 4A and 4B.

The processors of the CPU 202 and the storage/memory 204, although shown as a single component for representative purposes, may be multiple components, and may be outside of the home server 100 and/or the system 100′, and linked to the network 50.

The image processing module 211 performs various image processing operations to prepare photographs and/or images in various computer formats for use with texture maps.

The calibration module 212 includes algorithms which perform processes of matching points, such as those on a pattern 126a, which forms calibration surfaces on a flexible article 126, as placed on both a stencil 124, and an optional reference object 134, such as the reference object 134 (FIG. 1C), and creating a correspondence of these points. These points are then configured as texture maps, one portion for images of the stencil 124 and the other portion for the 3D model, by the texture mapping/texture map creation module 213, with texture maps permissible for example, for fronts and rears of the respective stencil/3D model pair. The texture map(s) (grouped texture maps in the case of more than one), e.g., one texture map for front sides and one texture map for rear sides of the stencil and 3D model (mesh). The texture map(s) are stored as such in the texture maps storage media 213a, or as metadata therein, with the corresponding actual texture maps stored in the cloud storage 110.

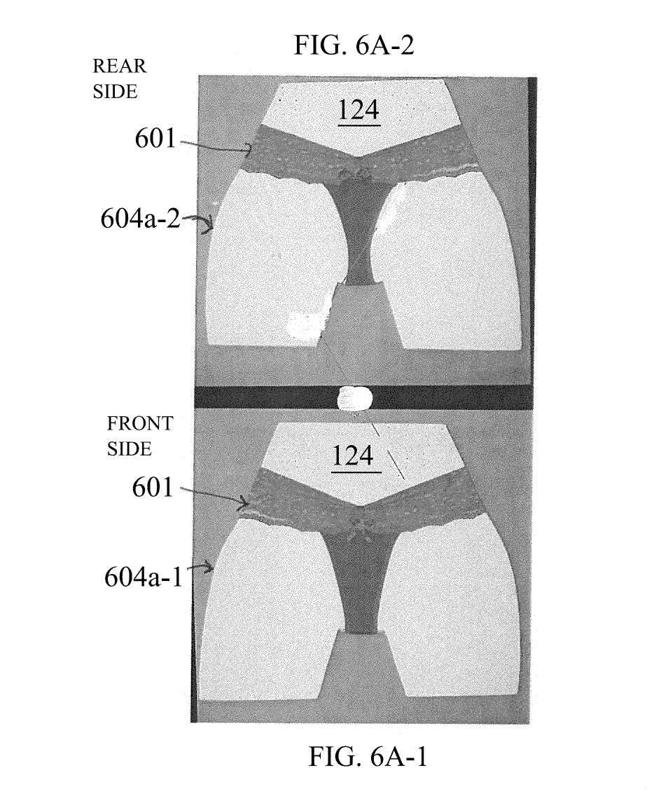

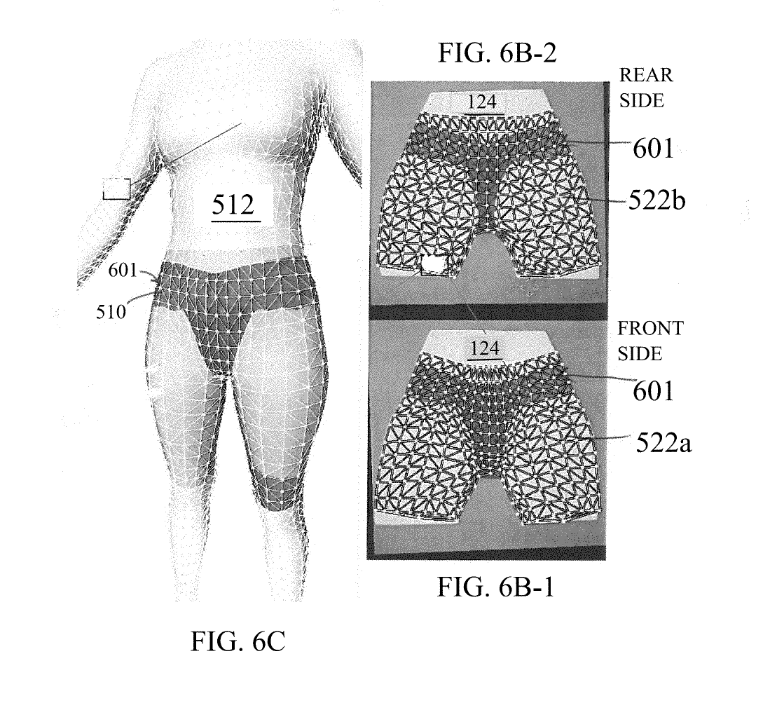

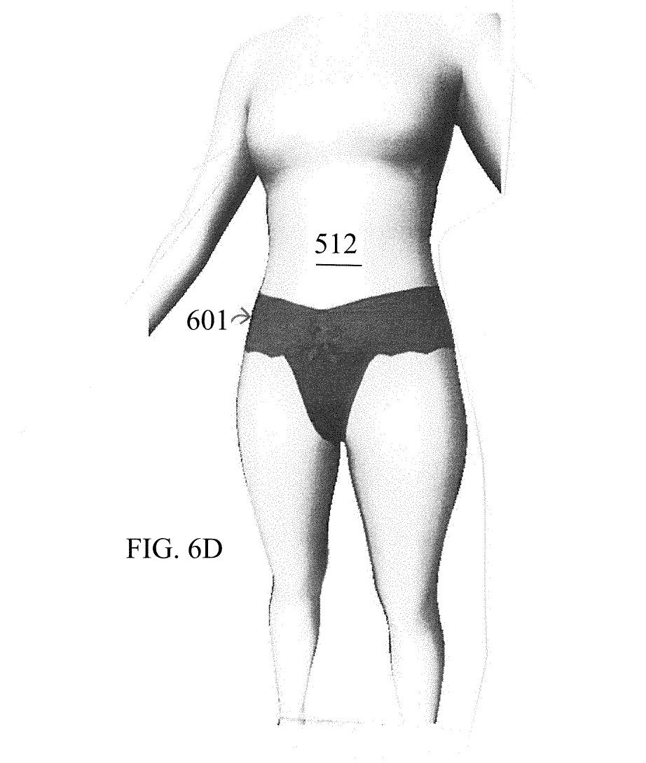

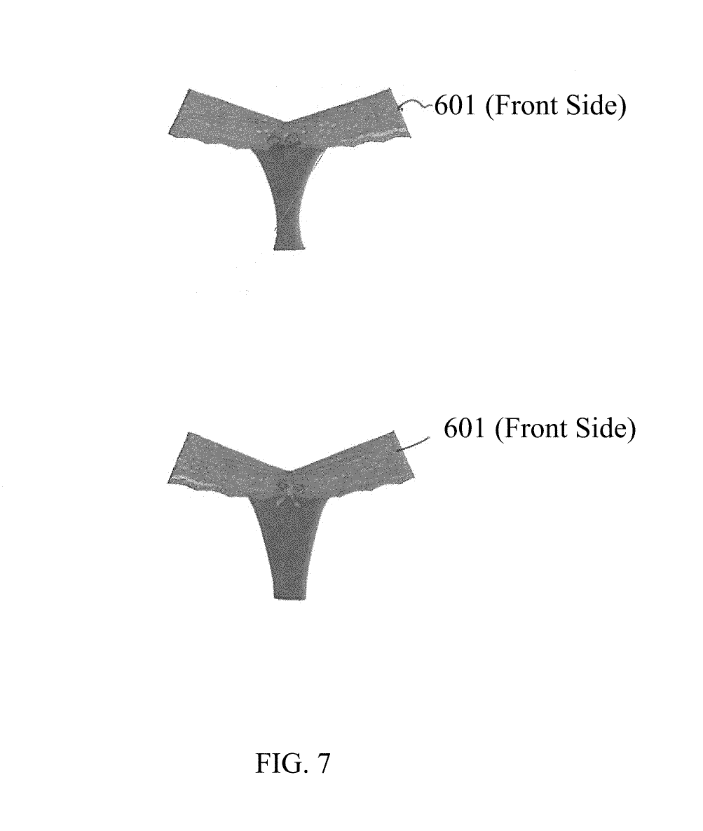

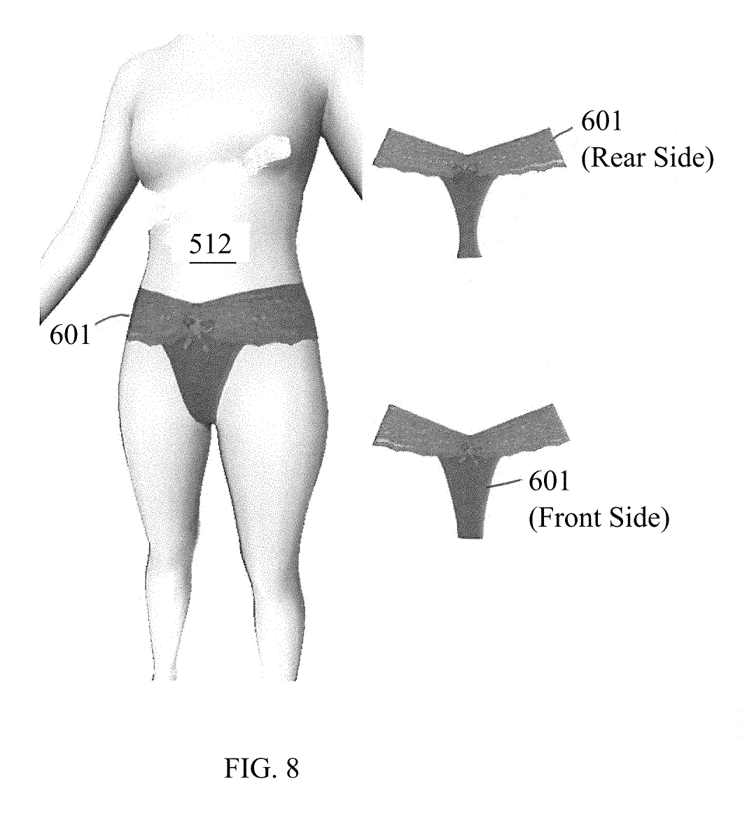

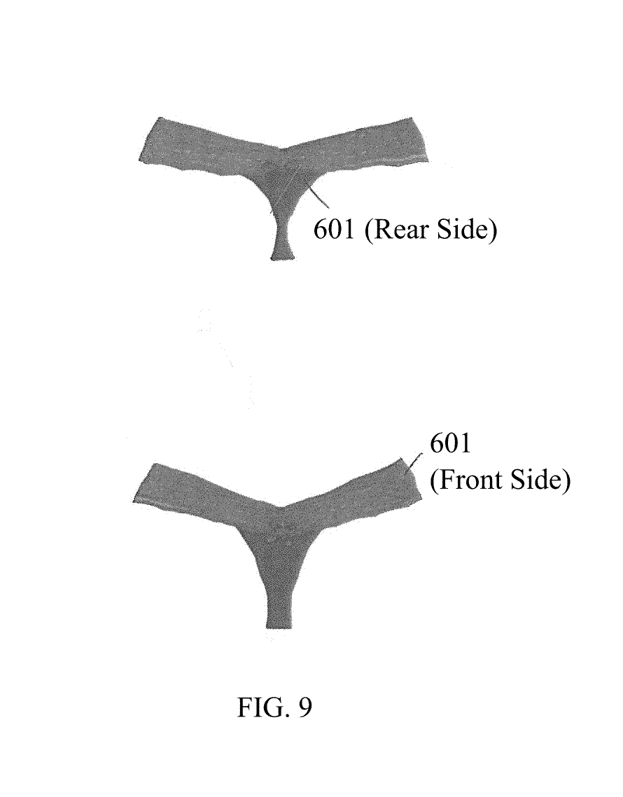

A modeling module 214 applies the texture map(s), such that the flexible article on the stencil 124, by virtue of the first or 2D texture map portion, is placed over the corresponding points or vertices of the mesh of the 3D model (the second or 3D texture map portion), and then rendering the article onto the 3D model, as shown in FIGS. 6C and 6D. The rendering involves using corresponding points or vertices on the 2D texture map portion associated with the 2D image(s), from the flexible article on the stencil to be modeled, and the mesh of the 3D model, to place or wrap the article on the 3D model. As a result, the flexible article is now on the 3D model, so as to permit a virtual try-on of the flexible article.

The resultant modelings, e.g., the flexible article, for example, the clothing article, on the 3D model, may be stored. Storage is in either the modeling storage media 214b, or as metadata therein, with the corresponding modelings stored in the cloud storage 110.

Attention is now directed to FIGS. 3, 4A and 4B, which show flow diagrams detailing computer-implemented processes in accordance with embodiments of the disclosed subject matter. Reference is also made to elements shown in FIGS. 1A, 1B, 1C and 2. The process and subprocesses of FIGS. 3, 4A and 49 include both computerized processes performed by the system 100′, as well as some alternate manual processes. The aforementioned processes and sub-processes can be, for example, performed in real time. Reference is also made to the diagrams of FIGS. 5A-1, 5A-2, 59, 5C-1, 5C-2, 5D, 6A-1, 6A-2, 6B-1, 6B-2, 6C and 6D, when describing the processes of FIGS. 3, 4A and 4B, as detailed below.

FIG. 3 details the overall process of the invention. This overall process involves at least two stages or portions. A first stage or portion is a calibration process, at block 400, and described in detail in FIG. 4A. This calibration process is such that the system 100′, at block 400, calibrates a stencil 124 to a 3D model by creating at least one texture map from photographs of a calibration surface on the stencil coordinated with points (vertices) of a mesh of the 3D model. Next is a modeling process or stage, which involves a modeling process, at block 450, which is detailed in FIG. 4B. This modeling process of block 450 involves modeling another flexible article, typically different than the flexible article used for the calibration, on the 3D model, using photographs of the other flexible article on the stencil, and the texture map(s) created during the calibration process (block 400), by the system 100′. Additionally, there is a START block 300, prior to the calibration process (block 400), where once the stencil and 3D model are created and/or obtained, the process begins at block 400. Once the modeling process (stage) of block 450 is complete, the process moves to block 480, where another flexible article may be modeled on the 3D model. If so, the process returns to block 450, from where it resumes. If not, the process moves to block 490, where it ends.

FIG. 4A illustrates the calibration process of block 400 in detail, while FIG. 4B illustrates the modeling process of block 450 in detail. The texture map portions, i.e., the 2D mesh of the UV portion, and the mesh of the 3D model are shown in the drawing figures as visible, to enhance illustration of the invention. This showing as visible is for illustration purposes, as in the actual computer graphics, these texture map portions need not be visible.

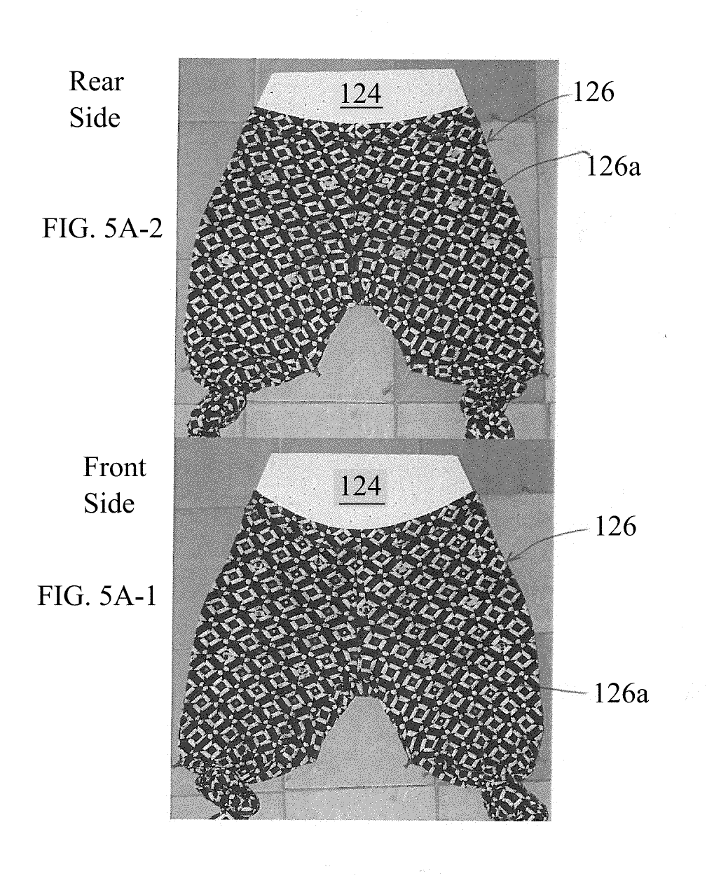

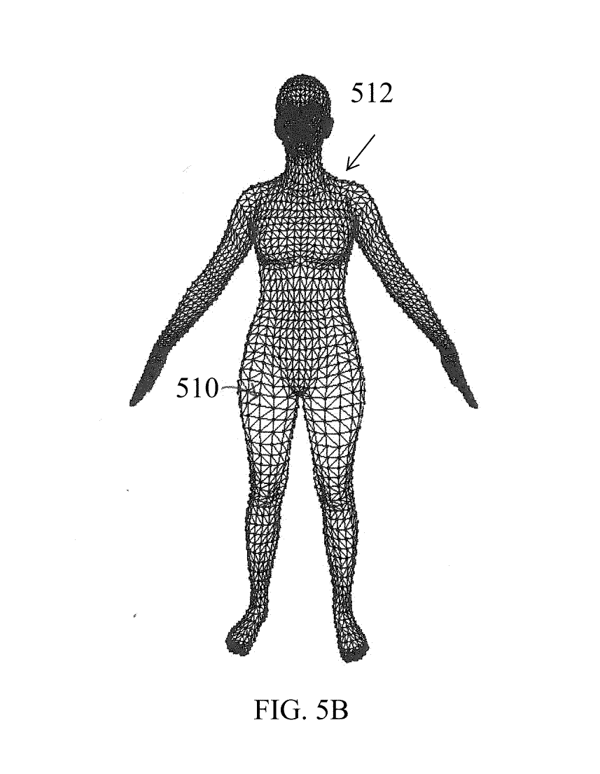

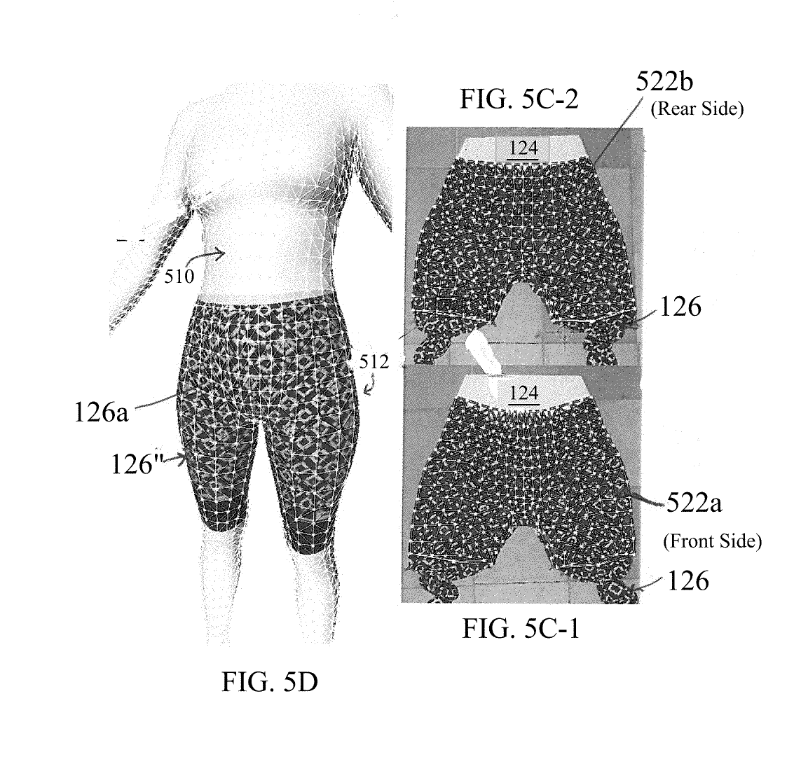

FIG. 4A illustrates the calibration process of block 400 in detail. Initially, at block 401a, a stencil 124, known, for example, as Stencil X, for purposes of this example, such as that shown in FIGS. 1A and 1B, is obtained. A calibration surface, for example, a unique pattern 126a on a pair of shorts 126, such as a checkerboard pattern, or other pattern is placed onto the stencil 124, as shown in FIG. 5A-1 (front) and 5A-2 (rear). One or more images are acquired of the stencil 124, front or front side (hereinafter “front”) and rear or rear side (hereinafter “rear”), with the calibration surface, at block 402. The process then moves to block 403.

Contemporaneous with block 401a, a 3D model, represented by a mesh (for example, a 3D mesh), is obtained at block 401b. This 3D model may be obtained from websites, represented by the TPS 115, such as Turbosquid™ of New Orleans, La. (www.turbosquid.com), or from a manually drawn graphic. This 3D model may be stored in the model storage 214a. The process then moves to Hock 403.

The process moves to block 403, where a texture map is created. For example, one or more texture maps are each created, by correlating points or vertices of the mesh 510 of the 3D model 512, of FIG. 5B, with points or vertices on the 2D or UV map, of the stencil 124.

This correlation is, for example, obtained by first transforming the points or vertices from the mesh 510 of the 3D model 512 onto the irnage(s) (e.g., photographs or computer graphics) of the calibration surface, i.e., the pattern 126a of the flexible object 126 on the stencil 124, to create the 2D texture map portions 522a, as shown in FIG. 5C-1 (stencil 124 image, front side), 522b, as shown in FIG. 5C-2 (stencil 124 image, rear side). Each of the 2D texture map portions is formed of points or vertices, corresponding or matching to vertices or points of the mesh 512 of the 3D model 512, which form the 3D texture map portions. This transformation can be performed using computer graphics, such as Blender 2.77 (detailed above), or drawn manually. The flexible article 126″ is now rendered onto the mesh 510 of the 3D model 512 by correlating points or vertices of the 2D texture map portion, to the corresponding (e.g., matching) points or vertices of the (respective) 3D texture map portion(s) of the mesh 510 of the 3D model 512, as shown in FIG. 5D. The rendering is, for example, performed by a rendering engine from OpenGL, from Khronos Group of Beverton, Oreg. (www.openGL.org).

Optionally, the graphic designer moves points or vertices of the 2D portion of the texture map, and performs the rendering again, until the calibration surface 126a appears to be properly positioned on the 3D model. This may be repeated for as long as is necessary.

Optionally, at block 403′ the calibration surface 126a may be placed onto a reference object 134, such as a human model 135, mannequin or other human form, as a guide for the computer operator and/or graphic designer to assist in creating the texture map(s).

From block 403, the process moves to block 404, where the one or more created texture maps are stored, for example, as a portion(s) for the 2D UV map (2D mesh), with portion(s) of the mesh (3D mesh) for the corresponding 3D model. The texture map(s) are stored in the storage media 213a. Alternately, the storage media 213a stores metadata, for the aforementioned texture map(s), with the texture map(s) stored. in the cloud storage 110.

The calibration of block 400 is now complete, as one or more texture maps have been created for a stencil, e.g., Stencil X, and a corresponding 3D model.

The modeling process (stage) of block 450 now occurs, where the texture maps from the calibration process of block 400 are used in modeling a flexible article such as clothing, for example, underwear, on a 3D model.

FIG. 4B shows the modeling process of block 450 in detail. Initially, at block 451 the same stencil 124 (FIGS. 1A and 1B), e.g., Stencil X, is obtained. The process then moves to block 452, where another flexible article, e.g., the pair of polka dot shorts 128 (FIG. 1) or here, for example, an undergarment (other article) 601, is placed on the stencil 124, and one or more images (front 604a-1 of FIG. 6A-1, rear 604a-2 of FIG. 6A-2), in the form of photographs and/or computer graphics, thereof are acquired. The process then moves to block 454.

Contemporaneous with one or both of blocks 451 and 452, the same 3D model 512 (FIG. 5B), e.g., which was used in the calibration process of block 400, is obtained, at block 453. This 3D model 512 is used in modeling this other article 601. The process then moves to block 454.

At block 454, one or more texture map(s), for the stencil and the 3D model, are obtained. These texture map(s) are obtained, for example, from the storage media 213a, or cloud storage 110, as detailed above. The process then moves to block 455.

At block 455 the texture map's/maps' 2D portion for the stencil 124 The corresponding 3D portion of the texture map is the mesh 510 for the 3D model 512. The superimposition is such that the images/graphics 604a-1 and 604a-2 are aligned with the respective calibrated stencil 124 texture map portion, as shown in FIGS. 6B-1 and 6B-2. For example, this can be done by transforming the photographs/images to align the stencil images 604a-1, 604a-2 with respective front 522a and rear 522b stencils using software tools, such as Matlab®, or by transforming the 2D portion of the texture map(s) to match the stencil images 604a-1, 604a-2.

Portions of the background and the stencil 124, which are not relevant can be removed, either automatically, by computer graphics tools, or manually.

The process then moves from block 455 to block 456. At block 456, a model is created. This model is created, for example, in the form of a graphic or other image of the other article 601, which is rendered or placed on the 3D model 512. This is done by mapping the image(s) or texture image(s) of the article 601 on the stencil 124, (as shown in FIGS. 6B-1 and 6B-2) by using the 2D portion(s) of the texture map(s), to the corresponding portion(s) of the mesh 510 of the 3D model 512, and then rendering the article 601 onto the 3D model, as shown in FIG. 6C. The rendering involves using corresponding (e.g., matching) points or vertices, on the image(s) and the mesh of the 3D model, to place or wrap the article on the 3D model. The rendering is performed, for example, by the rendering engine from OpenGL, from Khronos Group of Beverton, Oreg. (www.openGL.org), as detailed above. Additionally, pixel color of the rendered image can be calculated by using the texture map(s) portions as detailed above.

The process now moves to block 457a, an optional process for making corrections. At block 457a, it is determined whether corrections are needed. If, no, the process moves to block 458, where it ends.

However, should corrections be needed at block 457a, the process moves to block 457b.

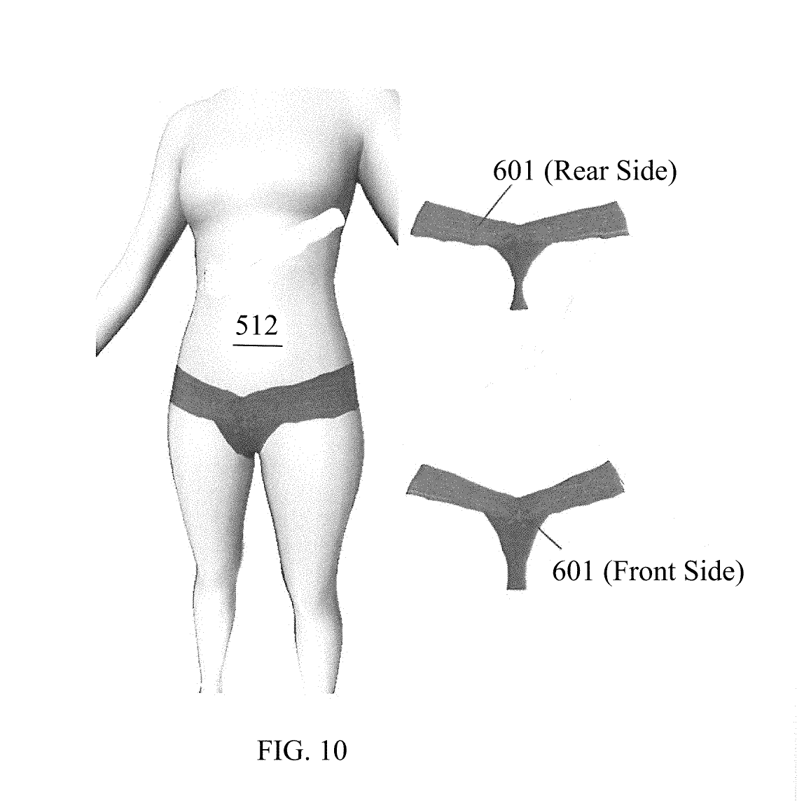

At block 457b, these corrections may be made by manipulating the 2D UV map(s), either or both of the 2D and 3D mesh points, points or vertices of the texture maps), warping the image, color correction, and the like, such that the process moves to block 456. At block 456, the process resumes, as another rendering of the 3D model is performed. This correction followed by another modeling is shown in a sequence, from FIG, 7 to FIG. 10.

With process of block 456 complete, a virtual try-on of the article 601 on a 3D model is achieved, for example, as shown in FIG. 6D.

Alternately, the process of blocks 457a and 457b can be completely bypassed if desired, whereby the process moves directly to block 458.

At block 458, the modeled flexible article 601 on the 3D model is then stored in storage media 214b, or as metadata therein, with the data for the image of modeled flexible article 601 on the 3D model stored in the cloud storage 110.

The invention is also such that it can be stored on a machine-accessible medium. Embodiments of the invention may be represented as a software product stored on a machine-accessible medium (also referred to as a computer-accessible medium or a processor-accessible medium). The machine-accessible medium may be any type of magnetic, optical, or electrical storage medium including a diskette, CD-ROM, memory device (volatile or non-volatile), or similar storage mechanism. The machine-accessible medium may contain various sets of instructions, code sequences, configuration information, or other data, such as those for performing the processes detailed in FIGS. 3, 4A and 4B, as detailed above. Those of ordinary skill in the art will appreciate that other instructions and operations necessary to implement the described invention may also be stored on the machine-accessible medium. The machine-accessible medium comprises instructions, that when executed by a machine causes the machine to perform operations comprising performing the processes detailed in FIGS. 3, 4A and 4B, as detailed above.

The implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the drawings (drawing figures) illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the Hock diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software, The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended, to embrace all such alternatives, modifications and variations that fall within the spirit and broad scope of the appended claims.

1. A computer-implemented method for mapping graphics onto a three dimensional (3D) model, comprising:
calibrating a form to a graphical representation of a 3D model by creating a east one texture map from at least one image of a first article on the form; and,
graphically rendering a second article on the graphical representation of the 3D model from images of the second article on the form, by applying the images to the graphical representation of the 3D model in accordance with the calibration of the form to the graphical representation of the 3D model.

2. The method of claim 1, wherein the form includes a stencil.

3. The method of claim 2, wherein the first and second articles are flexible articles, different from each other.

4. The method of claim 3, wherein the flexible articles include at least one of clothing, underwear, shorts, bras, swimsuits, and form-fitting clothing.

5. The method of claim 1, wherein the graphical representation of the 3D model includes a mesh, defining a three dimensional (3D) portion of the at least one texture map.

6. The method of claim 1, wherein the images of the first article on the form include photographs.

7. The method of claim 5, wherein the calibrating includes:
obtaining at least one image of a calibration surface of the first flexible article on the stencil, the calibration surface defined by a pattern on the first flexible article; and,
obtaining the graphical representation of the 3D model in the form of a mesh, the mesh including points in a predetermined order.

8. The method of claim 7, wherein the at least one texture map is created by correlating points from the mesh of the graphical representation of the 3D model to points of the calibration surface of the first flexible article on the stencil.

9. The method of claim 8, wherein the predetermined points of the mesh of the graphical representation of the 3D model and the points of the calibration surface define vertices, and the vertices of the mesh of the graphical representation of the 3D model are correlated to the vertices of the calibration surface to define the at least one texture map, the vertices of the calibration surface defining a two dimensional portion of the at least one texture map associated with the stencil.

10. The method of claim 9, wherein the graphically rendering comprises:
obtaining at least one image of a second flexible article on the stencil;
obtaining the graphical representation of the 3D model including the mesh; and, obtaining the at least one texture map associated with the stencil and the graphical representation of the 3D model.

11. The method of claim 10, additionally comprising: superimposing the two dimensional portion of the at least one texture map associated with the stencil over the at least one image of the second flexible article on the stencil.

12. The method of claim 11, additionally comprising: mapping the two dimensional portion of the at least one texture map associated with the stencil to the mesh of the graphical representation of the 3D model via the correlated vertices.

13. The method of claim 12, additionally, comprising: rendering the second flexible article onto the mesh of the graphical representation of the 3D model using the correlated vertices to wrap the second flexible article onto the graphical representation of the 3D model.

14. A computer system for mapping graphics onto a three dimensional (3D) model, comprising:
a processor; and
a data storage device having stored thereon instructions, which when executed by the processor, cause the computer system to perform operations comprising:
calibrating a form to a graphical representation of a 3D model by creating at east one texture map from at least one image of a first article on the form; and,
graphically rendering a second article on the graphical representation of the 3D model from images of the second article on the form as applied to the graphical representation of the 3D model in accordance with the calibration of the form to the graphical representation of the 3D model.

15. The computer system of claim 14, wherein the form includes a stencil.

16. The computer system of claim 15, wherein the first and second articles are flexible articles, different from each other.

17. The computer system of claim 16, wherein the flexible articles include at least one of clothing, underwear, shorts, bras, swimsuits, and form-fitting clothing.

18. The computer system of claim 14, wherein the graphical representation of the 3D model includes a mesh, defining a portion of the at least one texture map.

19. The computer system of claim 14, wherein the images of the first article on the form include photographs.

20. The computer system of claim 4, wherein the calibrating comprises:
obtaining at least one image of a calibration surface of the first flexible article on the stencil, the calibration surface defined by a pattern on the first flexible article; and,
obtaining the graphical representation of the 3D model in the form of a mesh, the mesh including points in a predetermined order.

21. The computer system of claim 20, wherein the at least one texture map is created by correlating points from the mesh of the graphical representation of the 3D model to points of the calibration surface of the first flexible article on the stencil.

22. The computer system of claim 21, wherein the predetermined points of the mesh of the graphical representation of the 3D model and the points of the calibration surface define vertices, and the vertices of the mesh of the graphical representation of the 3D model are correlated to the vertices of the calibration surface to define the at least one texture map, the vertices of the calibration surface defining a two dimensional portion of the at least one texture map associated with the stencil.

23. The computer system of claim 22, wherein the graphically rendering comprises:
obtaining at least one image of a second flexible article on the stencil;
obtaining the graphical representation of the 3D model including the mesh; and,
obtaining the at least one texture map associated with the stencil and the graphical representation of the 3D model.

24. The computer system of claim 23, wherein the graphically rendering additionally comprises:
superimposing the two dimensional portion of the at least one texture map associated with the stencil over the at least one image of the second flexible article on the stencil.

25. The computer system of claim 24, wherein the graphically rendering additionally comprises:
mapping the two dimensional portion of the at least one texture map associated with the stencil to the mesh of the graphical representation of the 3D model via the correlated vertices.

26. The computer system of claim 25, wherein the graphically rendering additionally comprises:
rendering the second flexible article onto the mesh of the graphical representation of the 3D model using the correlated vertices to wrap the second flexible article onto the graphical representation of the 3D model.

27. A non-transitory computer-readable medium having stored thereon instructions that are executable to cause a computer system to perform operations comprising:
calibrating a stencil to a graphical representation of a 3D model by creating at least one texture map from at least one image of a first article on the form; and,
graphically rendering a second article on the graphical representation of the 3D model from images of the second article on the stencil as applied to the graphical representation of the 3D model in accordance with the calibration of the stencil to the graphical representation of the 3D model.

28. The non-transitory computer-readable medium of claim 27, wherein the first and second articles are flexible articles, different from each other, and, the flexible articles include at least one of clothing, underwear, shorts, bras, swimsuits, and form-fitting clothing.

29. The non-transitory computer-readable medium of claim 28, wherein the graphical representation of the 3D model includes a mesh, defining a portion of the at least one texture map.

30. The non-transitory computer-readable medium of claim 29, wherein the images of the first article on the stencil include photographs.

31. The non-transitory computer-readable medium of 27, wherein the calibrating comprises:
obtaining at least one image of a calibration surface of the first flexible article on the stencil, the calibration surface defined by a pattern on the first flexible article; and,
obtaining the graphical representation of the 3D model in the form of a mesh, the mesh including points in a predetermined order.

32. The non-transitory computer-readable medium of claim 31, wherein the at least one texture map is created by correlating points from the mesh to points of the calibration surface of the first flexible article on the stencil.

33. The non-transitory computer-readable medium of claim 32, wherein the predetermined points of the mesh of the graphical representation of the 3D model and the points of the calibration surface define vertices, and the vertices of the mesh of the graphical representation of the 3D model are correlated to the vertices of the calibration surface to define the at least one texture map, the vertices of the calibration surface defining a two dimensional portion of the at least one texture map associated with the stencil.

34. The non-transitory computer-readable medium of claim 33, wherein the graphically rendering comprises:
obtaining at least one image of a second flexible article on the stencil;
obtaining the graphical representation of the 3D model including the mesh; and,
obtaining the at least one texture map associated with the stencil and the graphical representation of the 3D model.

35. The non-transitory computer-readable medium of claim 34, wherein the graphically rendering additionally comprises:
superimposing the two dimensional portion of the at least one texture map associated with the stencil over the at least one image of the second flexible article on the stencil.

36. The non-transitory computer-readable medium of claim 35, wherein the graphically rendering additionally comprises:
mapping the two dimensional portion of the at least one texture map associated with the stencil to the mesh of the graphical representation of the 3D model via the correlated vertices.

37. The non-transitory computer-readable medium of claim 36, wherein the graphically rendering additionally comprises:
rendering the second flexible article onto the mesh of the graphical representation of the 3D model using the correlated vertices to wrap the second flexible article onto the graphical representation of the 3D model.
